(19) United States
(12) Patent Application Publication
(10) Pub. No.: US 2024/0270036 A1
(43) Pub. Date: Aug. 15, 2024

(54) Coupling Apparatus

(71) Applicant: ACPS Automotive GmbH, Ingersheim (DE)

(72) Inventors: Wolfgang Gentner, Steinheim (DE); Aleksej Kadnikov, Leonberg (DE); Stefan Nägele, Besigheim (DE)

(73) Assignee: ACPS Automotive GmbH, Ingersheim (DE)

(21) Appl. No.: 18/437,487

(22) Filed: Feb. 9, 2024

(30) Foreign Application Priority Data
Feb. 13, 2023 (DE) 10 2023 103 438.3

(51) Int. Cl. B60D 1/52

(52) U.S. Cl. CPC B60D 1/52

(57) ABSTRACT

In order to fix the carrier element reliably in an operating position relative to the holding unit, it is proposed that a locking apparatus is arranged on the holding unit, that the locking apparatus is arranged in a housing held on the holding unit, that, by means of a locking body, the locking apparatus fixes the carrier element, at least in an operating position, relative to the holding unit in that the locking body protrudes in a fixing position out of the housing and cooperates with the carrier element.

The present disclosure relates to the subject matter disclosed in German application number 10 2023 103 438.3 of 13 Feb. 2023, which is incorporated herein by reference in its entirety and for all purposes.

### BACKGROUND OF THE INVENTION

The invention relates to a coupling apparatus comprising a carrier unit which is mountable at a rear side on a vehicle bodywork, a holding unit held on the carrier unit and a carrier element for a coupling element, said carrier element being mounted on the holding unit pivotable relative to said holding unit by means of a pivot bearing unit about a pivot axis for a coupling element, wherein the coupling element is configured either for pulling a trailer or for carrying a load carrier.

Coupling apparatuses of this type are known from the prior art.

With these known coupling apparatuses, the problem exists of providing a solution of simple and stable construction.

### SUMMARY OF THE INVENTION

In accordance with an embodiment of the invention, provision is made in a coupling apparatus of the aforementioned type that the holding unit has a guide body on which the pivot bearing unit is arranged, by means of which pivot bearing unit, bearing cheeks of the carrier element are mounted on the guide body, and in that the guide body extends with at least one portion in a direction parallel to the pivot axis from one bearing cheek to the other bearing cheek.

The advantage of an embodiment of the invention lies therein that therewith a simple stable guidance of the pivot movement of the carrier element is possible in a compact construction.

It is particularly favorable if the guide body comprises a guide portion which carries guide surfaces arranged on both sides thereof for guiding the bearing cheeks and extends parallel to the pivot axis between these guide surfaces, in particular from one guide surface to the other guide surface.

Therewith, an embodiment according to the invention is provided ensuring a simple, compact and stable guidance of the bearing cheeks.

In particular, for example, the guide portion can be a body formed by parts directly connected to one another, in particular by joining, for example, in the manner of a housing.

It is particularly advantageous if the guide portion is formed by a single-piece body which, for example, can also be a forged part or can be formed by a segment of an extruded profile.

Suitably, the guide body is therein configured such that it extends parallel to the pivot axis with a cross-sectional area perpendicular to the pivot axis, the areal extent of said cross-sectional area corresponding to at least the areal extent of the guide surfaces.

The guide body is preferably also a body formed by parts directly connected to one another, in particular by joining.

Thus, in the simplest case, the guide body can also be formed by a forged part or by a portion of an extruded profile.

Alternatively thereto, the body is also formed by a single-piece body, also, for example, in the form of a forged part or a portion of an extruded profile.

With regard to the fixing of the carrier unit, a great variety of different possibilities are conceivable.

Preferably, the guide body is not connected directly to the carrier unit, but by means of a connecting unit.

Such a connecting unit can be formed as a single piece on the guide body.

However, this requires the connecting unit and the guide body to be configured specifically for the respective vehicle type.

A further advantageous embodiment of the invention relating to the connecting unit provides that the connecting unit is formed of two flange elements arranged at a spacing from one another which thereby create the connection between the guide body and the carrier unit.

Flange elements of this type have the advantage that they can be easily adapted to a wide variety of geometries and thus, for example, to the wide variety of spatial proportions of different vehicle types, whereas the guide body can remain the same in each case.

The flange elements are therein preferably configured such that they receive at least a partial region of the guide body between them.

Advantageously, the flange elements are therein fixed to mutually opposite sides of the guide body, for example, by joining, in particular welding.

In this case, for example, the flange elements can be welded onto the sides of the guide body.

In order to create as stable a connection as possible between the flange elements and the guide body, it is preferably provided that the flange elements are supported with support regions on support bodies arranged on the guide body.

This provides the possibility, for example, of forming the flange elements such that they have support regions, for example support edges, adapted to the support bodies and that, in particular, the flange elements enter into positive-lockingly operative connections with the support bodies in directions parallel to their areal extent.

An embodiment according to the invention is, alternatively or additionally to the features described above, particularly advantageous for coupling apparatuses in which the carrier element is arranged, in the rest position, between the holding unit and a rear region of the vehicle bodywork.

Suitably, the carrier element is herein pivotable by means of the pivot bearing unit about a pivot axis which extends transversely, in particular perpendicularly, to a longitudinal central plane of the motor vehicle or to a longitudinal central plane of the coupling apparatus coinciding with this longitudinal central plane of the motor vehicle.

It is achievable in a particularly simple manner by means of a shape of the pivot axis of this type, that the carrier element is moved from the operating position into a rest position which is arranged between the holding unit and the rear region of the motor vehicle, in particular in the direction of travel, in front of the holding unit under the bumper unit and outside a visible region, whereas the carrier element is arranged in the operating position such that it lies under a lower edge of the bumper unit and thus positions the coupling element such that it can extend rearwardly under the lower edge of the bumper unit opposite to the direction of travel of the motor vehicle, behind the bumper unit.

A particularly advantageous embodiment of the invention provides alternatively or additionally to the embodiment of the invention described in the introduction that the carrier element is configured as a receptacle body with a receptacle for an inserting portion of the ball neck.

A particularly favorable embodiment of the invention provides that in the operating position of the receptacle body, the receptacle is arranged on a region of the holding unit, in particular the guide body thereof, facing toward a roadway.

Particularly advantageously, the holding unit, in particular the guide body thereof, is then configured, if it has a support surface which, with the inserting portion of the coupling element inserted into the receptacle of the receptacle body which is disposed in the operating position, abuts the inserting portion and thereby blocks a pivoting of the receptacle body relative to the holding unit, in particular to the guide body thereof, in at least one pivoting direction, for example a pivoting from the operating position into the rest position.

It is particularly advantageous if, with the inserting portion of the ball element inserted in the receptacle body which is disposed in the operating position, the support surface blocks a pivot movement of the receptacle body from the operating position in each direction.

An advantageous embodiment of the invention provides that the support surface is arranged on the holding unit, in particular on the guide body thereof, at a spacing from the pivot bearing unit.

It is particularly favorable if the support surface is arranged on a side of the pivot bearing unit facing toward the receptacle.

It is particularly advantageous if, with the receptacle body disposed in the operating position, the support surface extends parallel to a central axis of the receptacle and is thus able to be brought in an optimal manner into abutment with, and can influence, the inserting portion of the coupling element.

It is further suitable if, in the operating position of the receptacle body, the support surface forms, in a direction transverse to the central axis of the receptacle, at least a partial region, preferably the whole, of a wall surface delimiting the receptacle.

Preferably, the support surface is further configured so that in the operating position of the receptacle body, in the direction of the central axis of the receptacle, it delimits at least a subportion of the receptacle, preferably the whole receptacle.

In particular, it is suitably provided that, in the operating position of the receptacle body, the support surface is arranged on a side of the receptacle facing the pivot bearing unit.

A further advantageous embodiment of the invention provides that the receptacle body is configured at least partially U-shaped in the region of the receptacle and has an open side in which, in the operating position of the receptacle body, the support surface arranged on the holding body is situated.

Preferably with an embodiment according to the invention, the holding unit, in particular the guide body thereof, is configured such that it has an operating position end stop which blocks the pivot movement of the receptacle body from the rest position in the direction of the operating position on reaching the operating position.

Another advantageous embodiment of the invention provides that the receptacle body is provided with an end stop body which, in the operating position, abuts the operating position end stop.

It is therein conceivable, for example, to provide an operating position end stop arranged directly on the holding unit.

A further advantageous embodiment of the invention provides that there is provided on the holding unit a rest position end stop which blocks a pivot movement of the receptacle body from the operating position into the rest position on reaching the rest position.

Alternatively or in addition to the embodiment of the invention described above, in accordance with an embodiment of the invention, provision is made in a coupling apparatus of the type mentioned in the introduction that a locking apparatus is arranged on the holding unit, that the locking apparatus is arranged in a housing held on the holding unit, that, by means of a locking body, the locking apparatus fixes the carrier element, at least in an operating position, relative to the holding unit, in particular also without the inserting portion being inserted into the receptacle body, that the locking body protrudes in a fixing position out of the housing and cooperates with the carrier element.

The advantage of an embodiment according to the invention is found, firstly, therein that, by means of the arrangement of the locking apparatus in a housing held on the holding unit, the locking apparatus is protected and therefore operates in a functionally reliable manner and in that, secondly since, in a fixing position, the locking body protrudes out of the housing and cooperates with the carrier element, a fixing of the carrier element at least in the operating position can be realized in a simple manner.

It is particularly advantageous if the housing is included by the holding unit, in particular by a guide body thereof so that the housing can be accommodated in a simple manner in the holding unit.

A particularly advantageous embodiment of the invention provides that the housing is part of the holding unit, in particular part of a guide body thereof and thus no additional housing must be arranged on the holding unit, but rather a part of the holding unit can form the housing.

It is particularly favorable if the housing is integrated into the guide body of the holding unit.

In the simplest case, it is therein provided that the holding unit, in particular a guide body thereof, comprises a multi-piece or single-piece body, in an advantageous case, a forged body or a body made from an extruded profile which receives the housing so that thereby the locking apparatus can be integrated into the holding unit in a space-saving manner.

A further advantageous embodiment of the invention provides that, in the at least one fixing position, the locking body of the locking apparatus blocks a movement of the carrier element out of the operating position and that the locking body is movable in a movement direction from the at least one fixing position into a releasing position in which the carrier element is pivotable out of the operating position into a rest position, in particular provided that no inserting portion is inserted into the receptacle body.

Preferably, on moving from the fixing position into the releasing position, the locking body is therein movable into the housing.

A further advantageous embodiment of the invention provides that a blocking of the carrier element in the rest position takes place with the locking body.

A further advantageous embodiment of the invention provides that, for blocking the carrier element in the operating position, the locking body is movable into a first fixing position and that, for blocking the carrier element in the rest position, is movable into a second fixing position, wherein, in particular, the locking body protrudes to a different extent beyond the housing in the first and the second fixing positions.

For example, in this regard it is provided that, in the first fixing position, the locking body protrudes less far beyond the housing than in the second fixing position and therein cooperates, in each case, with the carrier element.

With regard to the triggering of the movements of the locking body, no further details have yet been provided.

Thus, an advantageous embodiment of the invention provides that the locking body of the locking apparatus is resiliently urged by an actuating unit in the direction of the at least one fixing position.

This means that the locking body is always independently movable from the releasing position into the at least one fixing position or, if needed, is movable into the first and the second fixing position.

Preferably, the actuating unit is therein arranged in the housing.

An advantageous embodiment of the actuating unit provides that it has an actuating body arranged in the housing, said actuating body being acted upon by a resilient element, wherein the actuating body influences the locking body, in particular, is fixedly connected to the locking body.

In order to guide the actuating body, it is suitably therein provided that the housing forms a guiding receptacle for the actuating body.

In an advantageous exemplary embodiment, the guiding receptacle is therein configured for the actuating body as a guide channel in the housing so that thereby the guiding can be realized easily in the housing.

In principle, the actuating body could be movable in the movement direction between the fixing position and the releasing position on a curved path, wherein if required, the locking body is also movable on a curved path.

However, a particularly advantageous embodiment of the invention provides that the actuating body is movable in a linear manner in the movement direction between the least one fixing position and the releasing position.

To move the locking body from the at least one fixing position into the releasing position, different possibilities are conceivable.

One possibility would be a direct influence on the locking body.

A particularly advantageous embodiment of the invention provides, however, that an influence on the locking body to move it in the movement direction takes place by means of an influence on the actuating unit.

It is therein suitably provided that the influence on the actuating unit to move the locking body from the at least one fixing position into the releasing position takes place by means of an actuating transmission, wherein the actuating transmission preferably influences the actuating body.

Therein, the influence on the locking body to move it from the at least one fixing position into the releasing position can take place by means of a manual action.

Another advantageous embodiment of the invention provides that the influence on the locking body to move it from the at least one fixing position into the releasing position takes place by means of a drive unit controlled by a control system.

Another possibility for fixing the carrier element in the rest position provides that for fixing the carrier element in the rest position, a detent apparatus is provided.

Preferably, the detent apparatus is configured so that an actuation of the detent apparatus to release it correlates, in particular is coupled, with an influencing of the carrier element to move said carrier element from the rest position in the direction of the operating position.

It is therein also advantageous if the actuation of the detent apparatus correlates, in particular is coupled, with the actuation of the locking body.

It is herein preferably provided that an influence on the locking body to move it from the at least one fixing position into the releasing position correlates with the transference of the detent apparatus from a detent position into a detent releasing position.

Alternatively to the provision of an operating position end stop arranged directly on the holding unit, it is also possible that the operating position end stop is connected to the locking body and is movable therewith.

Alternatively or additionally to the features described above, the problem addressed by the invention also lies in reliably fixing the carrier element in an operating position relative to the holding unit.

A further advantageous embodiment of the invention provides that the locking apparatus is arranged on the holding unit, in particular on a guide body thereof, in a region between the carrier unit and the receptacle disposed in the operating position.

An embodiment of the invention of particularly favorable construction provides that the locking apparatus is arranged on the holding unit, in particular on a guide body thereof, between bearing cheeks of the receptacle body mounted by means of the pivot bearing unit on the holding unit.

It is further preferably provided that the locking apparatus is arranged on the holding unit, in particular on a guide body thereof, on a side of the support surface facing away from the receptacle disposed in the operating position.

A further advantageous embodiment of the invention provides that the locking apparatus is arranged on the holding unit, in particular on a guide body thereof, between the pivot bearing unit and the support surface.

Further features and advantages of an embodiment according to the invention are the subject matter of the following description and of the illustration of some exemplary embodiments in the drawings.

The description above of embodiments according to the invention thus comprises, in particular, the different feature combinations defined by the following sequentially numbered embodiments:

1. A coupling apparatus comprising a carrier unit (22) which is mountable at a rear side on a vehicle bodywork (12), a holding unit (30) held on the carrier unit (22) and a carrier element (40) mounted on the holding unit (30) pivotable relative to said holding unit by means of a pivot bearing unit (110) about a pivot axis (104) for a coupling element (34), wherein the coupling element (34) is configured either for pulling a trailer or for carrying a load carrier, wherein the holding unit (30) has a guide body (90) on which the pivot bearing unit (110) is arranged, by means of which, bearing cheeks (75, 77) of the carrier element (40) are mounted on the guide body (90), and in that the guide body (90) extends with at least one portion (94) in a direction parallel to the pivot axis (104) from one bearing cheek (75, 77) to the other bearing cheek (77, 75).

2. The coupling apparatus according to embodiment 1, wherein the guide body (90) comprises a guide portion (94) which carries guide surfaces (96, 98) arranged on both sides thereof for guiding the bearing cheeks (75, 77) and extends parallel to the pivot axis between these guide surfaces (96, 98), in particular from one guide surface (96, 98) to the other guide surface (98, 96).

3. The coupling apparatus according to embodiment 2, wherein the guide portion is a body formed by parts directly connected to one another, in particular by joining.

4. The coupling apparatus according to embodiment 2, wherein the guide portion (94) is formed by a single-piece body.

5. The coupling apparatus according to one of the preceding embodiments, wherein the guide body (90) extends parallel to the pivot axis (104) with a cross-sectional area perpendicular to the pivot axis (104), the areal extent of said cross-sectional area corresponding to at least the areal extent of the guide surfaces (96, 98).

6. The coupling apparatus according to one of the preceding embodiments, wherein the guide body (90) is a body formed by parts directly connected to one another, in particular by joining.

7. The coupling apparatus according to one of the embodiments 1 to 6, wherein the guide body (90) is formed by a single-piece body.

8. The coupling apparatus according to one of the preceding embodiments, wherein the guide body (90) is connected to the carrier unit (22) by means of a connecting unit (92, 210).

9. The coupling apparatus according to embodiment 8, wherein the connecting unit (92) is formed as a single piece on the guide body (90).

10. The coupling apparatus according to embodiment 8 or 9, wherein the connecting unit is formed from two flange elements (212, 214) arranged spaced from one another.

11. The coupling apparatus according to embodiment 10, wherein the flange elements (212, 214) receive at least a partial region of the guide body (90) between them.

12. The coupling apparatus according to embodiment 10 or 11, wherein the flange elements (212, 214) are fixed to mutually opposite sides of the guide body (90).

13. The coupling apparatus according to one of the embodiments 10 to 12, wherein the flange elements (212, 214) are supported with support regions (226, 228, 236, 238) on support bodies (222, 224) arranged on the guide body (90).

14. The coupling apparatus according to embodiment 13, wherein the flange elements (212, 214) have support regions (226, 228, 236, 238) adapted in this manner to the support bodies (222, 224) and that, in particular, the flange elements (214, 216) enter into a positive-locking operative connection with the support bodies (222, 224) in directions parallel to their areal extent.

15. The coupling apparatus according to the preamble of embodiment 1 or according to one of the preceding embodiments, wherein, in the rest position, the carrier element (40) is arranged between the holding unit (30) and a rear region (14) of the vehicle bodywork (12).

16. The coupling apparatus according to one of the preceding embodiments, wherein the pivot axis (104) extends transversely, in particular perpendicularly, to a vertical longitudinal central plane (103) of the coupling apparatus.

17. The coupling apparatus according to the preamble of embodiment 1 or according to one of the preceding embodiments, wherein the carrier element (40) is configured as a receptacle body (32) with a receptacle (64) for an inserting portion (36) of the coupling element (34).

18. The coupling apparatus according to embodiment 17, wherein in the operating position of the receptacle body (32) the receptacle (64) is arranged on a region of the guide body (90) facing toward a roadway (54).

19. The coupling apparatus according to embodiment 17 or 18, wherein the holding unit (30), in particular the guide body (90), has a support surface (66) which, with the inserting portion (36) of the coupling element (34) inserted into the receptacle (64) of the receptacle body (32) which is disposed in the operating position, abuts the inserting portion (36) and thereby blocks a pivoting of the receptacle body (32) relative to the guide body (90) in at least one pivoting direction.

20. The coupling apparatus according to embodiment 19, wherein, with the inserting portion (36) of the coupling element (34) inserted into the receptacle body (32) in the operating position, the support surface (66) blocks a pivot movement of the receptacle body (32) from the operating position in each direction.

21. The coupling apparatus according to one of the embodiments 19 or 20, wherein the support surface (66) is arranged on the guide body (90) at a spacing from the pivot bearing unit (110).

22. The coupling apparatus according to one of the embodiments 19 to 21, wherein the support surface (66) is arranged on the guide body (90) on a side of the pivot bearing unit (110) facing toward the receptacle (64).

23. The coupling apparatus according to one of the embodiments 19 to 22, wherein, with the receptacle body (32) disposed in the operating position, the support surface (66) extends parallel to a central axis (68) of the receptacle (64).

24. The coupling apparatus according to one of the embodiments 19 to 23, wherein in the operating position of the receptacle body (32), the support surface (66) forms, in a direction transverse to the central axis (68) of the receptacle (64), at least a partial region, in particular the whole, of a wall surface delimiting the receptacle (64).

25. The coupling apparatus according to one of the embodiments 19 to 24, wherein in the operating position of the receptacle body (32), the support surface (66) delimits, in the direction of the central axis (68) of the receptacle (64), at least a subportion of the receptacle (64), in particular the whole receptacle (64).

26. The coupling apparatus according to one of the embodiments 19 to 25, wherein, in the operating position of the receptacle body (32), the support surface (66) is arranged on a side of the receptacle (64) facing toward the pivot bearing unit (110).

27. The coupling apparatus according to one of the embodiments 19 to 26, wherein the receptacle body (32) is configured at least partially U-shaped in the region of the receptacle (64) and has an open side in which, in the operating position of the receptacle body (32), the support surface (66) arranged on the holding body (30) is situated.

28. The coupling apparatus according to one of the embodiments 17 to 27, wherein the holding unit (30), in particular the guide body (90) thereof, has an operating position end stop (122) which blocks a pivot movement of the receptacle body (32) from the rest position in the direction of the operating position on reaching the operating position.

29. The coupling apparatus according to one of the embodiments 17 to 28, wherein the receptacle body (32) is provided with an end stop body (26) which, in the operating position, abuts the operating position end stop (122, 202).

30. The coupling apparatus according to one of the embodiments 17 to 29, wherein there is provided on the holding unit (30) a rest position end stop (124) which blocks a pivot movement of the receptacle body (32) from the operating position into the rest position on reaching the rest position.

31. The coupling apparatus according to the preamble of embodiment 1 or according to one of the preceding embodiments, wherein a locking apparatus (150) is arranged on the holding unit (30), in particular on a guide body (90) thereof, that the locking apparatus (150) is arranged in a housing (152) held on the holding unit (30), that, by means of a locking body (154), the locking apparatus (150) fixes the carrier element (40), at least in an operating position, relative to the holding unit (30) in that the locking body (154) protrudes in a fixing position out of the housing (152) and cooperates with the carrier element (40).

32. The coupling apparatus according to embodiment 31, wherein the housing (152) is included by the holding unit (30), in particular by a guide body (90) thereof.

33. The coupling apparatus according to embodiment 31 or 32, wherein the housing (152) is part of the holding unit (30), in particular of the guide body (90) thereof.

34. The coupling apparatus according to one of the embodiments 31 to 33, wherein the housing (152) is integrated into the guide body (90) of the holding unit (30).

35. The coupling apparatus according to one of the embodiments 31 to 34, wherein, in the at least one fixing position, the locking body (154) of the locking apparatus (150) blocks a movement of the carrier element (40) out of the operating position and is movable in a movement direction (156) from the at least one fixing position into a releasing position in which the carrier element (40) is freely pivotable out of the operating position into a rest position.

36. The coupling apparatus according to one of the embodiments 31 to 35, wherein with the locking body (154), a blocking of the carrier element (40) in the rest position takes place.

37. The coupling apparatus according to one of the embodiments 31 to 36, wherein, for blocking the carrier element (40) in the operating position, the locking body (154) is movable into a first fixing position and, for blocking the carrier element (40) in the rest position, is movable into a second fixing position.

38. The coupling apparatus according to one of the embodiments 31 to 37, wherein the locking body (154) of the locking apparatus (150) is resiliently urged by an actuating unit (160) in the direction of the at least one fixing position.

39. The coupling apparatus according to embodiment 38, wherein the actuating unit (160) is arranged in the housing (152).

40. The coupling apparatus according to embodiment 38 or 39, wherein the actuating unit (160) has an actuating body (162) arranged in the housing (152), said actuating body being acted upon by a resilient element (166).

41. The coupling apparatus according to embodiment 39 or 40, wherein the housing (152) forms a guiding receptacle (164) for the actuating body (162).

42. The coupling apparatus according to embodiment 41, wherein the guiding receptacle (164) for the actuating body (162) is configured as a guide channel (164) in the housing (152).

43. The coupling apparatus according to one of the embodiments 40 to 42, wherein the actuating body (162) is movable in a linear manner in the movement direction (156) between the least one fixing position and the releasing position.

44. The coupling apparatus according to one of the embodiments 31 to 43, wherein an influence on the locking body (154) to move it in the movement direction (156) takes place by means of an influence on the actuating unit (160).

45. The coupling apparatus according to one of the embodiments 31 to 44, wherein the influence on the actuating unit (160) to move the locking body (154) from the at least one fixing position into the releasing position takes place by means of an actuating transmission (170).

46. The coupling apparatus according to one of the embodiments 31 to 45, wherein an influence on the locking body (154) to move it from the at least one fixing position into the releasing position takes place by means of a manual action.

47. The coupling apparatus according to one of the embodiments 31 to 46, wherein an influence on the locking body (154) to move it from the at least one fixing position into the releasing position takes place by means of a drive unit (210) controlled by a control system (212).

48. The coupling apparatus according to one of the preceding embodiments, wherein a detent apparatus (190) is provided for fixing the carrier element (40) in the rest position.

49. The coupling apparatus according to embodiment 48, wherein an actuation of the detent apparatus (190) to release it correlates with an influencing of the carrier element (40) to move said carrier element from the rest position in the direction of the operating position.

50. The coupling apparatus according to embodiment 48 or 49, wherein the actuation of the detent apparatus (190) correlates with the actuation of the locking body (154).

51. The coupling apparatus according to one of the embodiments 48 to 50, wherein an influence on the locking body (154) to move it from the at least one fixing position into the releasing position correlates with the transference of the detent apparatus (190) from a detent position into a detent releasing position.

52. The coupling apparatus according to the preamble of embodiment 1 or according to one of the preceding embodiments, wherein the locking apparatus (150) is arranged on the holding unit (30), in particular, the guide body (90) thereof, in a region between the carrier unit (22) and the receptacle (64) disposed in the operating position.

53. The coupling apparatus according to embodiment 52, wherein the locking apparatus (150) is arranged on the holding unit (30), in particular on the guide body (90) thereof, between bearing cheeks (75, 77) of the receptacle body (32) which are mounted thereon by means of the pivot bearing unit (110).

54. The coupling apparatus according to one of the preceding embodiments, wherein the locking apparatus (150) is arranged on the holding unit (30), in particular, on the guide body (90) thereof, between the pivot bearing unit (110) and the support surface (66).

### BRIEF DESCRIPTION OF THE DRAWINGS

FIG. 1 shows a side view of a motor vehicle with a coupling apparatus held thereon with the carrier element disposed in an operating position and a coupling element inserted thereinto;

FIG. 2 shows a perspective view of a first exemplary embodiment of the coupling apparatus with a carrier element disposed in the operating position before an insertion of the coupling element when viewed from obliquely behind in the direction of the motor vehicle;

FIG. 3 shows a representation according to FIG. 2 with a view from the side of a rear region of the motor vehicle contrary to and obliquely to the direction of travel;

FIG. 4 shows a representation of the carrier element configured as a receptacle body in a perspective representation seen from behind in the direction toward the motor vehicle;

FIG. 5 shows a plan view of the receptacle body represented in FIG. 4, together with a schematic indication, in the operating position, of an inserted coupling element and a lower region of the holding unit facing toward a roadway;

FIG. 6 shows a perspective representation similar to FIG. 2 of the first exemplary embodiment with a representation of the carrier element disposed in the operating position, configured as a receptacle body without an inserted inserting portion of the coupling element, but with a representation of the pivot axis;

FIG. 7 shows a perspective representation similar to FIG. 6 with a carrier element disposed in a rest position and configured as a receptacle body;

FIG. 8 shows a section along the line 8-8 in FIG. 7;

FIG. 9 shows a perspective representation corresponding to FIG. 2 with a coupling element inserted into the carrier element which is configured as a receptacle body;

FIG. 10 shows a perspective representation similar to FIG. 3 with a coupling element inserted into the carrier element which is configured as a receptacle body;

FIG. 11 shows a longitudinal section through a holding unit held on the transverse carrier in a second exemplary embodiment with the carrier element configured as a receptacle body in the operating position and a locking body in the fixing position;

FIG. 12 shows a section similar to FIG. 12 with the locking body disposed in the releasing position according to the second exemplary embodiment;

FIG. 13 shows a section similar to FIG. 11 through the second exemplary embodiment with the carrier element disposed in the rest position;

FIG. 14 shows a perspective representation, similar to FIG. 10, of the second exemplary embodiment with the locking body disposed in a first fixing position;

FIG. 15 shows a section similar to FIG. 11 with the locking body disposed in the fixing position and the carrier element configured as a receptacle body disposed in the operating position;

FIG. 16 shows a section similar to FIG. 11 through a holding unit held on the transverse carrier according to a third exemplary embodiment with the receptacle body disposed in the operating position fixed in the operating position by a locking body in a first fixing position;

FIG. 17 shows a section similar to FIG. 13 with the carrier element configured as a receptacle body disposed in a rest position, locked by the locking body disposed in a second locking position;

FIG. 18 shows a section through a fourth exemplary embodiment with a first and a second locking body with the carrier element disposed in the operating position, configured as a receptacle body fixed by the first locking body and the second locking body in the first fixing position;

FIG. 19 shows a representation similar to FIG. 18 with the first locking body disposed in a releasing position, but with a second locking body still forming an end stop;

FIG. 20 shows a section similar to FIG. 18 with a carrier element configured as a receptacle body disposed in the rest position with locking bodies disposed in the second fixing position;

FIG. 21 shows a perspective representation of the fourth exemplary embodiment with the carrier element configured as a receptacle body, disposed in the operating position, locked in the operating position by the first locking body and the second locking body;

FIG. 22 shows a perspective representation of the carrier element disposed in the operating position and configured as a receptacle body in the operating position viewed toward an actuating element for actuating the locking apparatus;

FIG. 23 shows a perspective representation of a fifth exemplary embodiment with a carrier element disposed in the rest position and configured as a receptacle body with a drive unit for actuating the locking apparatus;

FIG. 24 shows a perspective representation of the carrier element configured as a receptacle body in the rest position in the fifth exemplary embodiment together with the drive unit and with a view toward a support surface of the holding unit;

FIG. 25 shows a perspective representation of a sixth exemplary embodiment with a view from the rear in the direction of the motor vehicle and the receptacle body disposed in the operating position;

FIG. 26 shows a side view of the sixth exemplary embodiment in the direction of the arrow A in FIG. 25;

FIG. 27 shows a side view similar to FIG. 26 with the side wall removed and with a view toward a guide body, and

FIG. 28 shows a perspective representation corresponding to FIG. 25 with a receptacle body disposed in the rest position.

### DETAILED DESCRIPTION OF THE INVENTION

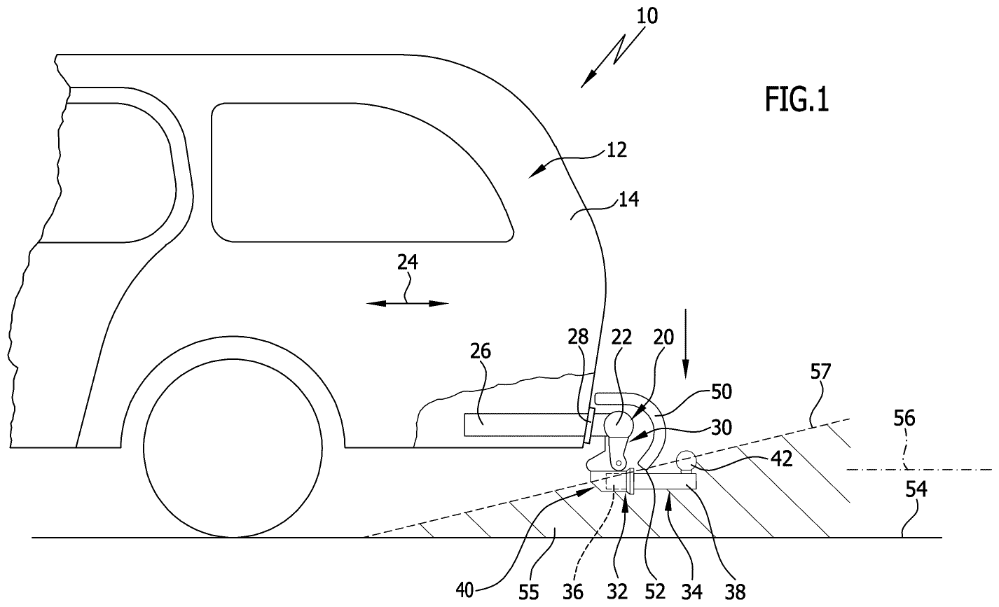

A motor vehicle identified in FIG. 1 overall as 10 comprises a vehicle bodywork 12 on which, at a rear region 14, a coupling apparatus 20 according to the invention is mounted.

The coupling apparatus 20 comprises as a carrier unit, for example, a transverse carrier 22 which extends transversely to a vehicle longitudinal direction 24 and is connected, for example, by means of side carriers 26 extending approximately parallel to the vehicle longitudinal direction 24 on bodywork portions also extending in the vehicle longitudinal direction 24 and/or by means of holding flanges 28, to the rear region 14 of the vehicle bodywork 12.

Provided on the transverse carrier 22 is a holding unit, identified overall as 30, which carries a carrier element, identified overall as 40, for example a receptacle body 32.

Insertable into this receptacle body 32, when it is disposed in an operating position, is a coupling element, identified overall as 34, with an inserting portion 36 which forms a first end of the coupling element 34, whereas a second end 38 of the coupling element 34 disposed opposite the inserting portion 36 and protruding rearwardly beyond the receptacle body 32 away from the vehicle bodywork 12 beyond the receptacle body 32, carries, for example, a coupling ball 42 or a carrier unit for loads connected to the coupling ball 42 or directly connected to the end 38, for example for bicycles or luggage.

In the motor vehicle according to the invention, the transverse carrier 22, end portions of the side carriers 26, for example, holding the transverse carrier 22 and/or holding flanges 28 holding the transverse carrier 22 are preferably covered by a bumper unit 50 of the vehicle bodywork 12, said bumper unit overlapping the transverse carrier 22 on an upper side facing away from a roadway 54 and on a rear side facing away from the rear region 14 of the vehicle bodywork 12 and also overlapping the holding unit 30 on its upper side facing away from the roadway 54 and on its side facing away from the rear region 14, so that on viewing the vehicle bodywork 12 from behind, only the receptacle body 32 beneath a lower edge 52 of the bumper unit and beneath a plane 56 extending parallel to the roadway 54 and through the lower edge in its operating position lies in a visible region 55.

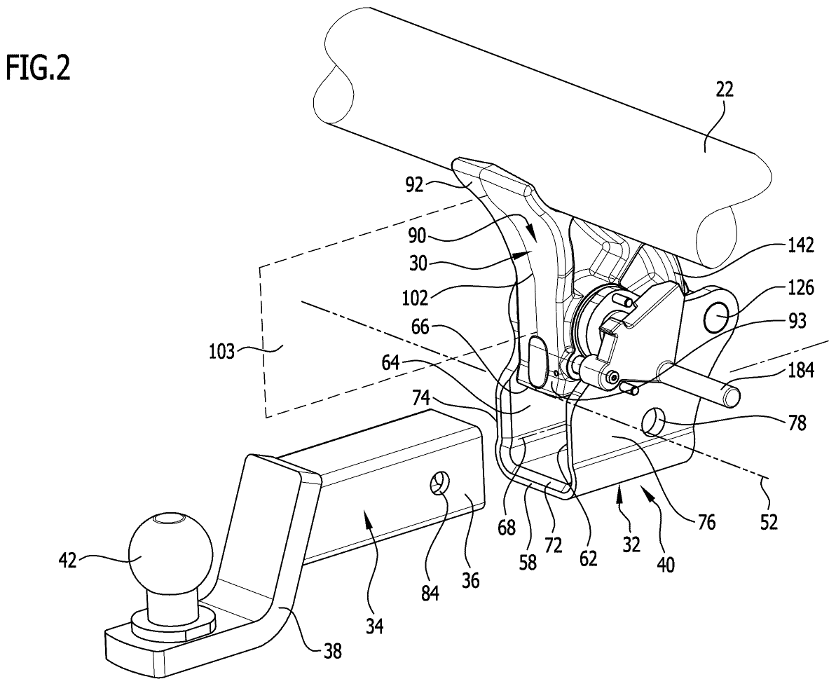

Thus, as shown in particular in FIG. 2, an inserting opening 62 situated on an end side 58 of the receptacle body 32 is visible in the operating position.

The visible region 55 is therein delimited by a line of sight 57 inclined by 15° relative to the roadway 54 and touching the lower edge 52 of the bumper unit 50 and is situated beneath it, as shown in FIG. 1.

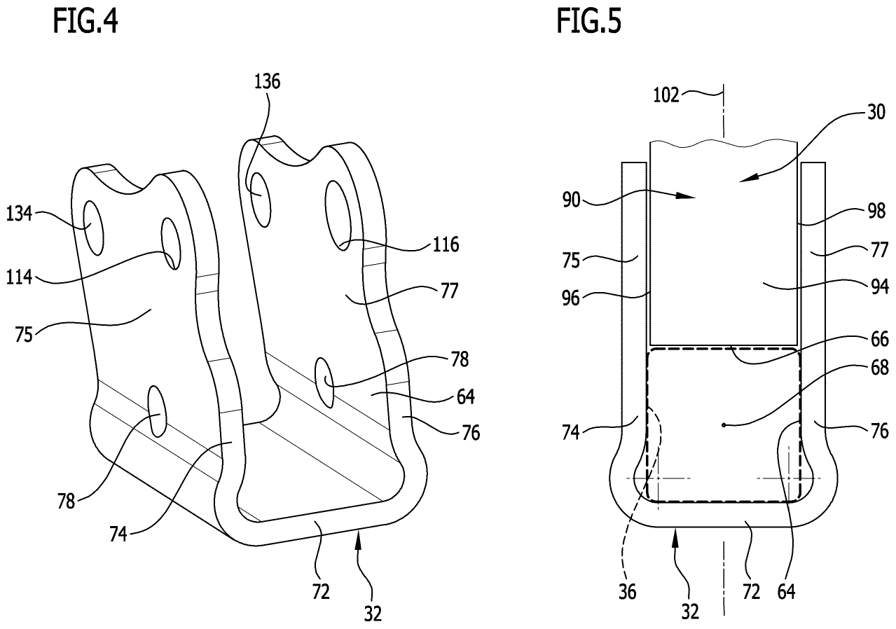

Starting from the inserting opening 62, as shown in FIG. 2 and FIGS. 3 to 5, a receptacle 64 extends into the receptacle body 32, wherein the receptacle 64 is adapted, for example, for receiving the inserting portion 36 which is adapted thereto, to a rectangular or square cross-sectional form, and is formed on a side facing toward the roadway 54 and on both sides extending transversely to the roadway 54 by the receptacle body 32 and, on a side facing away from the roadway 54, by a side of the holding unit 30 forming a support surface 66, as shown in FIGS. 2 and 5.

Preferably, as shown in FIGS. 1 to 5, in the operating position of the receptacle 64, a central axis 68 thereof extends approximately parallel to the direction of travel 24 and also approximately horizontally with the motor vehicle 10 standing on a horizontal roadway 54.

Therein, by “approximately parallel” and “approximately horizontal”, a deviation of up to 20° From exactly parallel and/or exactly horizontal should be understood.

The receptacle body 32 comprises, in particular, a lower transverse wall 72 facing the roadway 54, and transversely to said wall in the operating position, side walls 74 and 76 extending in the operating position away from the roadway 54, wherein in particular, the transverse wall 72 and the side walls 74 and 76 each extend approximately parallel to the central axis 68 in the operating position of the receptacle 64.

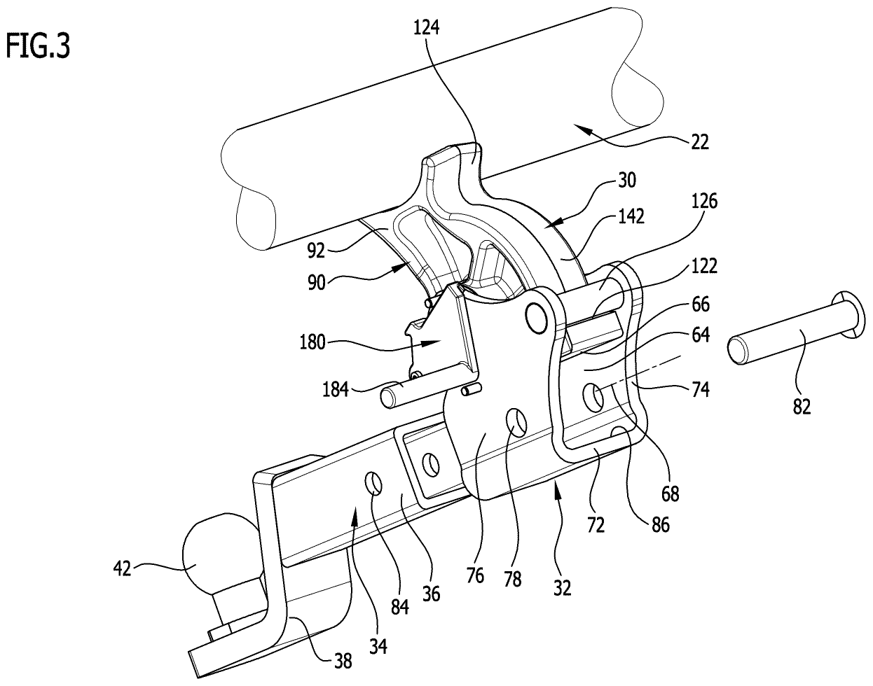

At a spacing from the inserting opening 62, the receptacle body 32 is provided in the region of the mutually opposing side walls 74 and 76 with apertures 78 through which a fixing pin 82 (shown in FIG. 3) can be pushed, in order also to pass the inserting portion 36 of the coupling element 34 inserted into the receptacle 66, through an aperture 84, and thus to fix said inserting portion relative to the receptacle body 32 so that it is immovably fixable in the receptacle 66 against movements in a direction parallel to the central axis 68.

Furthermore, the inserting portion 36 is also fixed in the receptacle 66 against a rotation movement about the central axis 68 in that the receptacle 64 has an approximately rectangular or square cross-sectional shape adapted to the inserting portion 36 and thereby is also fixed against movements transversely to the central axis 60, wherein an additional support takes place by way of the support surface 66 delimiting the receptacle 64 on the holding unit 30.

The inserting portion 36 of the coupling element 34 configured adapted to the receptacle 64 is thereby guided with little play both by the side walls 74 and 76 and also by the lower transverse wall 72 and the support surface 66 of the holding element 30 with the receptacle body 32 disposed in the operating position.

With an inserting portion 36 inserted into the receptacle 64 and adapted thereto, the inserting portion blocks a pivot movement of the receptacle body 32, due to the fact that the inserting portion abuts the support surface 66 of the holding unit 30, and thus also blocks a pivot movement of the carrier unit 40 out of the operating position, since the support surface 66 arranged stationary on the holding unit 30 predetermines the orientation of the inserting portion 36 relative to the holding unit 30 and thus also substantially the orientation of the receptacle body 32 relative to the holding unit 30.

Even on insertion of an inserting portion 36 with smaller dimensions, although the orientation thereof is significantly play-laden due to the receptacle 32 cooperating with the support surface 66, and thus the operating position of the receptacle body 32 can also vary as a result of the significant play, the operating position is however maintained despite the significant play, so that a trailer or a load carrier is, in principle, still connectable to the coupling element 34.

In this case, the fixing of the inserting portion 36 in the receptacle body 32 by means of the fixing pin 82 also acts in a supporting manner.

Preferably, the receptacle body 32 is configured so that the receptacle 64 extends, starting from the inserting opening 62, completely therethrough, specifically, for example, as far as a rear-side opening 86 situated opposite the inserting opening 62.

Thus, as shown in FIGS. 1 and 2, the receptacle body 32 is situated at a spacing from the roadway 54 such that however the receptacle body lies close to but below the plane extending through the lower edge 52 of the bumper unit 50 and approximately parallel to the roadway 54.

Thus, the coupling element 34 is easily insertable into the readily accessible inserting opening 62 of the receptacle 64 and the receptacle body 32 is also accessible such that, given good accessibility, the fixing pin 82 can be extended through the apertures 78 and 84.

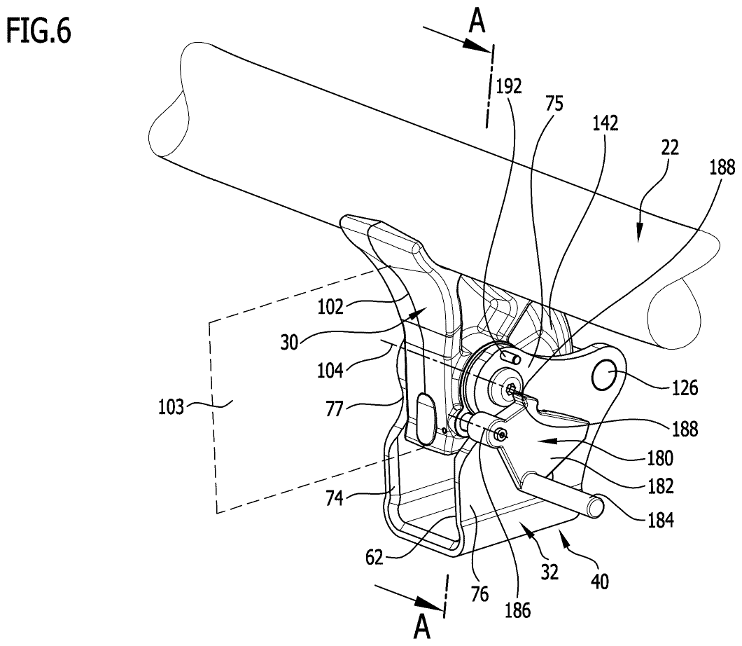

The holding unit 30 comprises, as illustrated in FIGS. 2, 3, 6 and 7, a connecting unit 92 extending, starting from the transverse carrier 22 in the direction of the roadway 54, said connecting unit being fixedly connected, for example, by means of a weld connection, to the transverse carrier 22 and transitioning into a guide body 90 connected thereto, preferably as a single piece, said guide body extending as far as its underside 93 forming the support surface 66 between bearing cheeks 75, 77 of the receptacle body 32 which are, for example, extensions of the side walls 74 and 76 of the receptacle body 32.

The receptacle body 32 encompasses a guide portion 94 of the guide body 90 which is situated on a side of the support surface 66 facing the transverse carrier 22 with the bearing cheeks 75, 77 on mutually opposite sides and abuts lateral guide surfaces 96 and 98 of the guide portion 94 of the guide body 90 extending from one of the guide surfaces 96, 98 to the other of the guide surfaces 98, 96 as a coherent body and is thereby movably guided relative to the guide body 90 parallel to a central plane 102 of the guide body 90, wherein the central plane 102 extends transversely to the transverse carrier 22, preferably perpendicularly to the transverse carrier 22.

In particular, the central plane 102 coincides with a vertical longitudinal central plane 103 of the coupling apparatus, which preferably extends parallel to the vehicle longitudinal direction 24 and is situated in the vertical vehicle longitudinal central plane.

Therein, the receptacle body 32 is pivotable relative to the guide body 90 about a pivot axis 104 which preferably extends perpendicularly to the central plane 102 and which is defined by a bearing pin 108 penetrating the guide body 90 in a pivot bearing receiving region 106, said bearing pin penetrating the bearing cheeks 75 and 77 of the receptacle body 32 on both sides of the pivot bearing receiving region 106 of the guide body 90 in the region of bearing bores 114 and 116 provided in said receptacle body 32.

Thus the pivot bearing receiving region 106 with the bearing pin 108 and the bearing bores 114 and 116 form a pivot bearing unit 110.

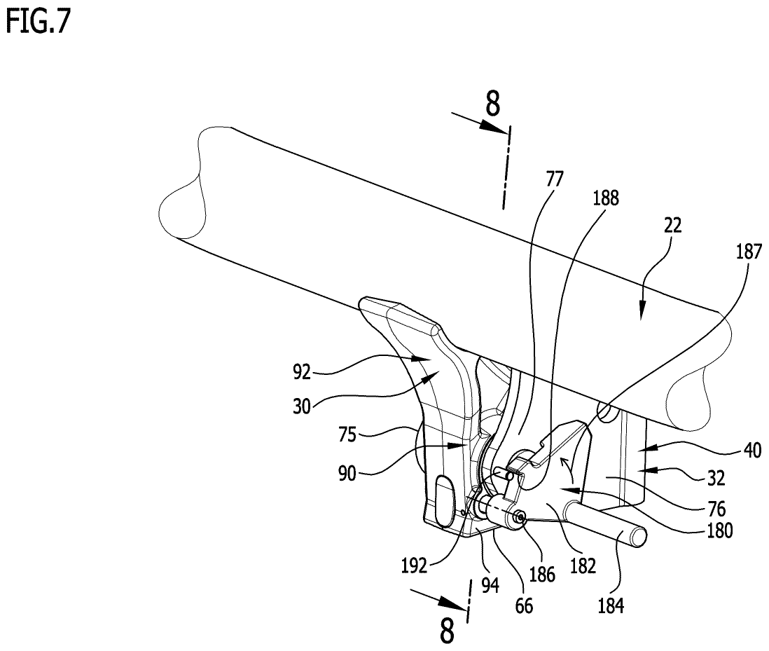

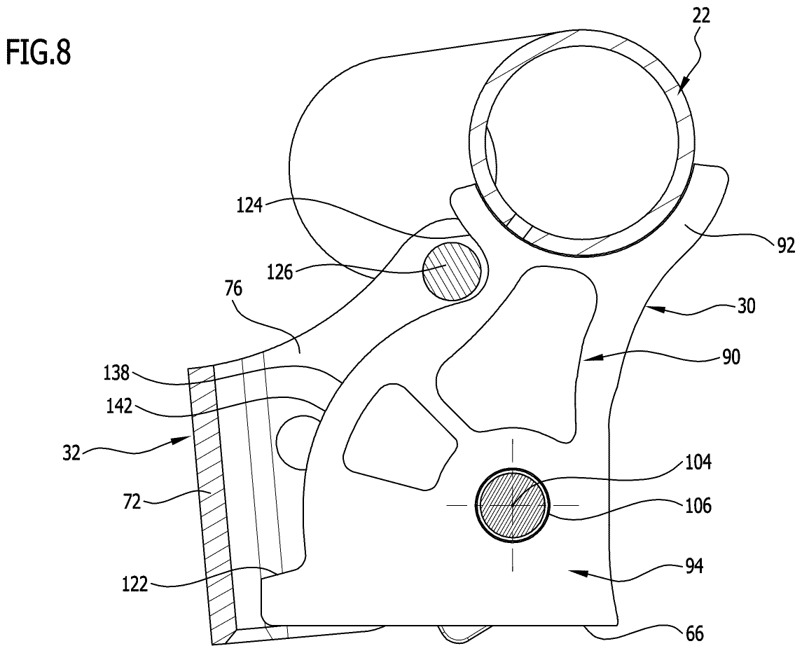

Thus, the receptacle body 32 is pivotable from the operating position represented in FIGS. 1 to 6 into a rest position represented in FIGS. 7 and 8 in which the lower transverse wall 72 of the receptacle body 32 is oriented transversely to the roadway 54 and is positioned between the holding unit 30 and the rear region 14 of the vehicle bodywork 12, wherein the lower transverse wall 72 is preferably oriented approximately perpendicularly to the roadway 54, that is, in an angular range of plus or minus 20° From a vertical to the roadway 54.

In order to define the operating position and the rest position of the receptacle body 32, the guide body 90 is provided with an operating position end stop 122 and a rest position end stop 124 against which an end stop body 126 which extends between the side walls 74 and 76 and is fixedly connected to the receptacle body 32 is abuttable, said end stop body being configured, for example, as a pin which is received, for example, in openings 134 and 136 in the side walls 74, 76 of the receptacle body 32 and is fixed therein.

Therein, the end stop body 126 moves on its route from the operating position, represented in FIGS. 2, 3 and 6, into the rest position, represented in FIGS. 7 and 8, along an outer contour 138 of the guide body 90 facing toward the rear region 14 of the motor vehicle, wherein the outer contour extends, for example, in the manner of a circular path about the pivot axis 104 in order additionally to guide the receptacle body 32 with a curved web 142 of the guide body 90 forming the outer contour 138, at the greatest possible spacing from the pivot axis 104 by placing it against an inner side of the side walls 74, 76 of the receptacle body 32.

Since, in the operating position, blocking takes place by means of the insertion, described above, of the inserting portion 36 into the receptacle 64, in principle, only a fixing of the carrier unit 40, in particular the receptacle body 32, in the rest position is still required.

For this, an external operating unit 180 is provided which is mounted on the guide body 90 to be pivotable about a rotation axis 186 in a detent direction 187.

The pivot rocker 182 is also provided with a detent nose 188 which, as shown in FIG. 7, cooperates with a detent element 192 held, for example, on the side wall 76 of the receptacle body 32, said detent element engaging, in the rest position of the receptacle body 32, behind the detent nose 188 which, due to the effect of a resilient element, is positioned in a detent position and is thus able to fix the receptacle body 32 in the rest position by means of the detent nose 188.

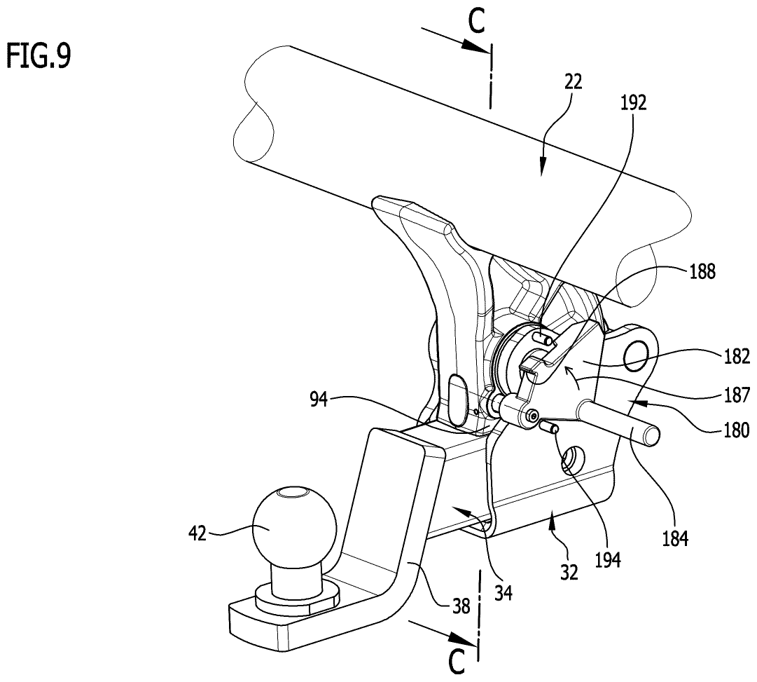

By means of a manual action on an actuating element 184, the pivot rocker 182 can be pivoted against its detent direction 187 to release the detent element 192 so that said pivot rocker acts upon an end stop 194 which is fixedly connected to the receptacle body 32, in particular the side cheek 77 thereof, with the consequence that thereby a pivoting of the carrier element 40, in particular, of the receptacle body 32 from the rest position into the operating position is brought about or assisted (FIGS. 7, 9).

For a second exemplary embodiment which also comprises the elements described above, reference is made to the entirety of the above description.

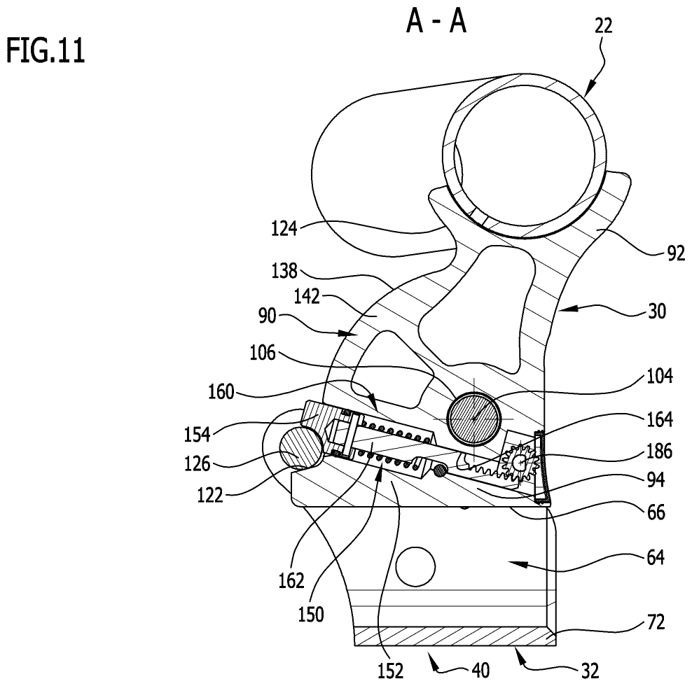

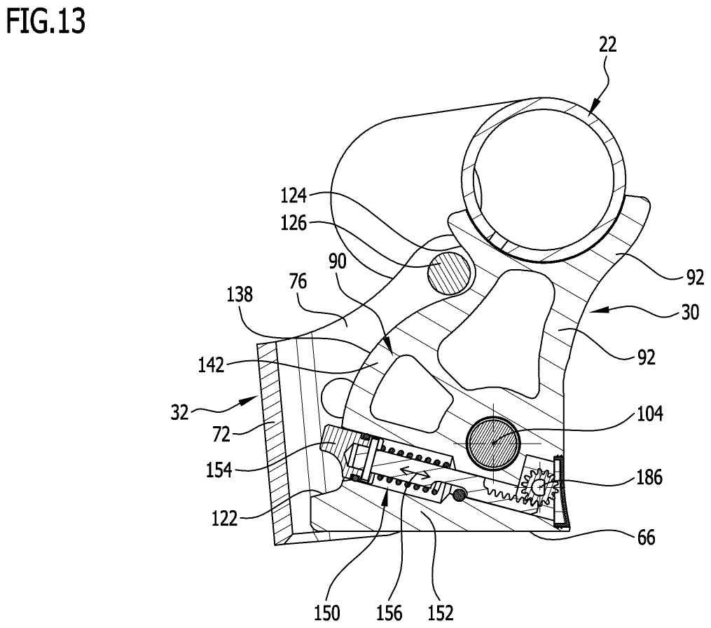

Furthermore, in the guide body 90, an additional locking apparatus 150 is also provided which is preferably arranged in the guide body 90 on a side of the underside 93 thereof facing away from the roadway 54, for example, in a housing 152 formed by the guide body 90, as shown in FIGS. 11 to 13.

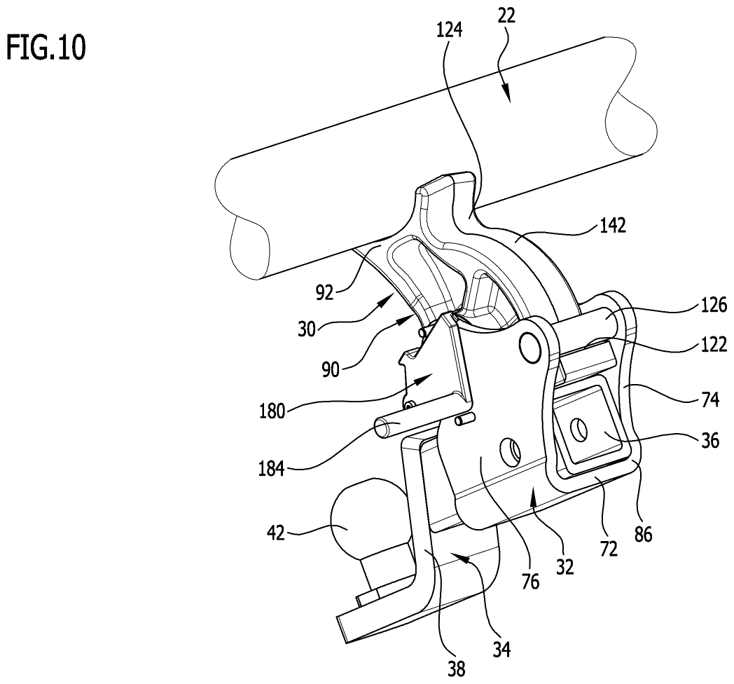

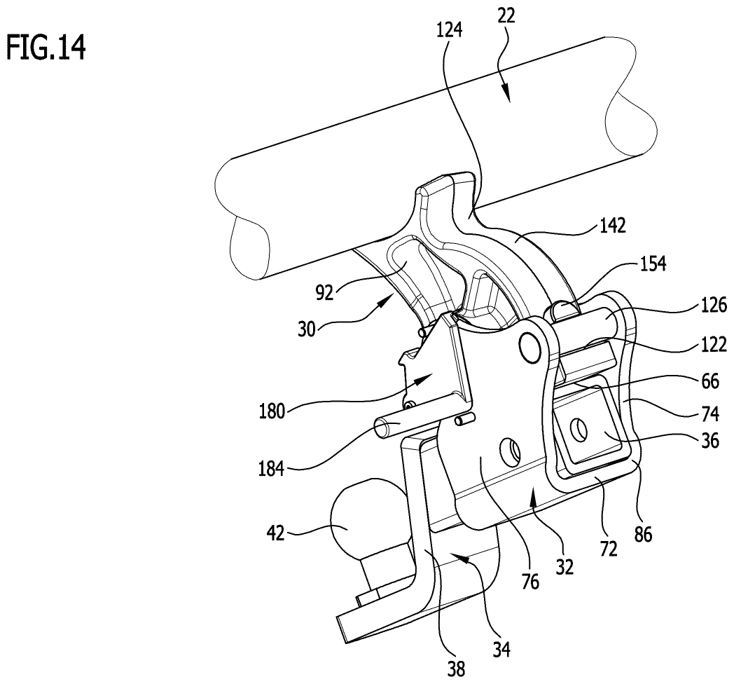

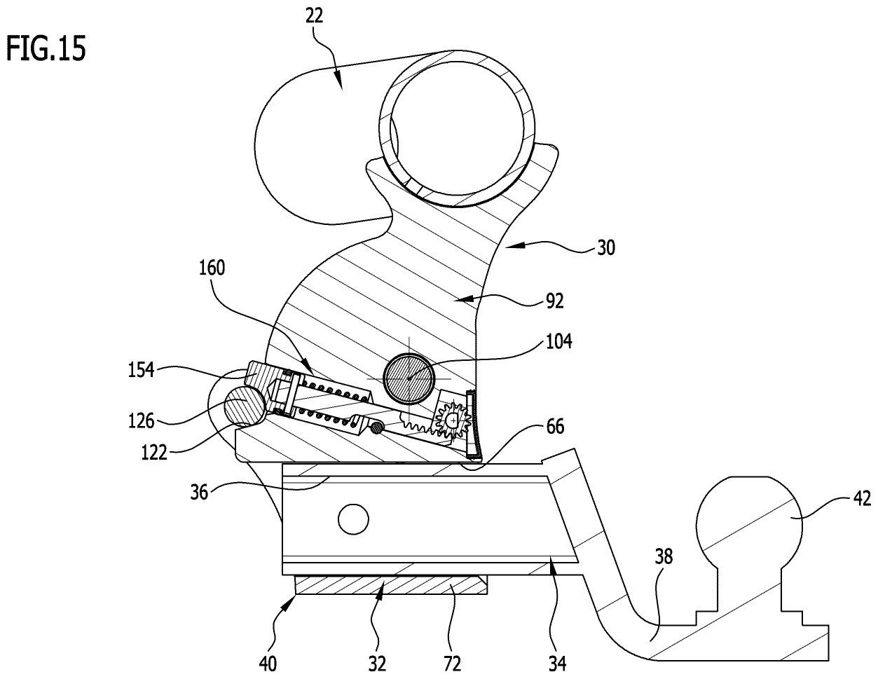

The locking apparatus 150 comprises a locking body 154 which is movable relative to the guide body 90 in a movement direction 156, so that, firstly, the locking body 154 as shown in FIGS. 11 and 14 is positionable at a spacing from the operating position end stop 122 so that when the receptacle body 32 is disposed in the operating position, the end stop body 126 connected to the receptacle body 32 is fixable between the locking body 154 and the operating position end stop 122 in order to prevent a pivot movement of the receptacle body 32 about the pivot axis 104, wherein preferably a substantially play-free fixing of the end stop body 126 in the operating position takes place, so that, as shown in FIGS. 10 and 11, the coupling element 34 is insertable with its inserting portion 36 into the receptacle 64 and is fixable, wherein the inserting portion 36 is supported, on one side, on the lower transverse wall 72 and the side walls 74 and 76 of the receptacle body 32 and, on the other side, also on the support surface 66 of the guide body 90, as shown by way of example in FIGS. 14 and 15.

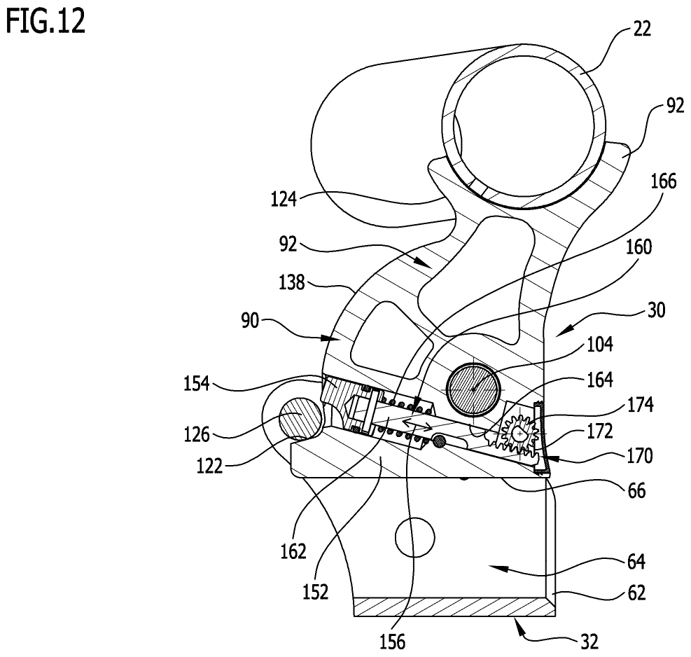

Proceeding from this fixing position, as shown in FIG. 11, the locking body 154 is movable by moving in the movement direction 156 so far relative to the end stop body 126, in particular into the housing 152, that the end stop body 126 is freely movable between the operating position end stop 122 and the rest position end stop 124 along the outer contour 138, as shown in FIG. 12.

For this, an actuating unit 160 for the locking body 154 is provided in the housing 152, said actuating unit comprising, for example, an actuating body 162 which is movable in the movement direction 156 and is movable, for example, in a guideway 164, preferably configured as a guide channel, in the housing 152 in order to carry out a linear movement in the movement direction 156.

Therein, the actuating body 162 is preferably fixedly connected to the locking body 154 and is acted upon by a resilient element 166 such that the actuating body 162 attempts to move the locking body 154 into its fixing position.

In order to move the locking body 154 together with the actuating body 162 out of the fixing position (FIG. 11), the actuating body 162 has an actuating transmission 170, formed for example, by a toothing 172 on the actuating body 162 and a drive gear 174, so that by rotating the drive gear 174, the actuating body 162 is movable, together with the locking body 154, into the releasing position shown in FIG. 12.

The actuating transmission 170 is coupled to the external operating unit 180′ which is non-rotatably coupled to the drive gear 174 and comprises, for example, the pivot rocker 182′ with the actuating element 184′, by means of which the pivot rocker 182 is pivotable about a rotation axis 186 of the drive gear 174 in order thereby to move the actuating body 162 together with the locking body 154 from the fixing position into the releasing position (FIG. 12).

In addition, the pivot rocker 182′ is also provided with the detent nose 188 which, as shown in FIG. 7, cooperates with the detent element 192 held, for example, on the side wall 76 of the receptacle body 32, said detent element engaging, in the rest position of the receptacle body 32, behind the detent nose 188 which, due to the effect of the resilient element 166, is disposed in its position corresponding to the fixing position of the locking body 154 and is thus able to fix the receptacle body 32 in the rest position by means of the detent nose 188.

This means that in both the operating position and the rest position of the receptacle body 32, the pivot rocker 182 of the operating unit 180 is disposed in the same rotation position relative to the rotation axis 186 and is pivotable, in each case, by a manual action on the actuating element 184 against the force effect of the resilient element 166, in order thereby, firstly, to unblock a pivot movement of the detent element 192 and thus of the receptacle body 32 in the rest position and to permit and to bring about or assist a pivot movement in the direction of the operating position, in which then a locking of the operating position by the locking body 154 disposed in the fixing position again takes place by means of a cooperation with the end stop body 126 and the operating position end stop 122.

Secondly, in the operating position, the possibility exists, by influencing the pivot rocker 182 by means of the actuating element 184, of pivoting the pivot rocker 182 far enough that the locking body 154 and the actuating body 162 transition from the fixing position into the releasing position and thus permit a pivoting of the receptacle body 132 from the operating position into the rest position.

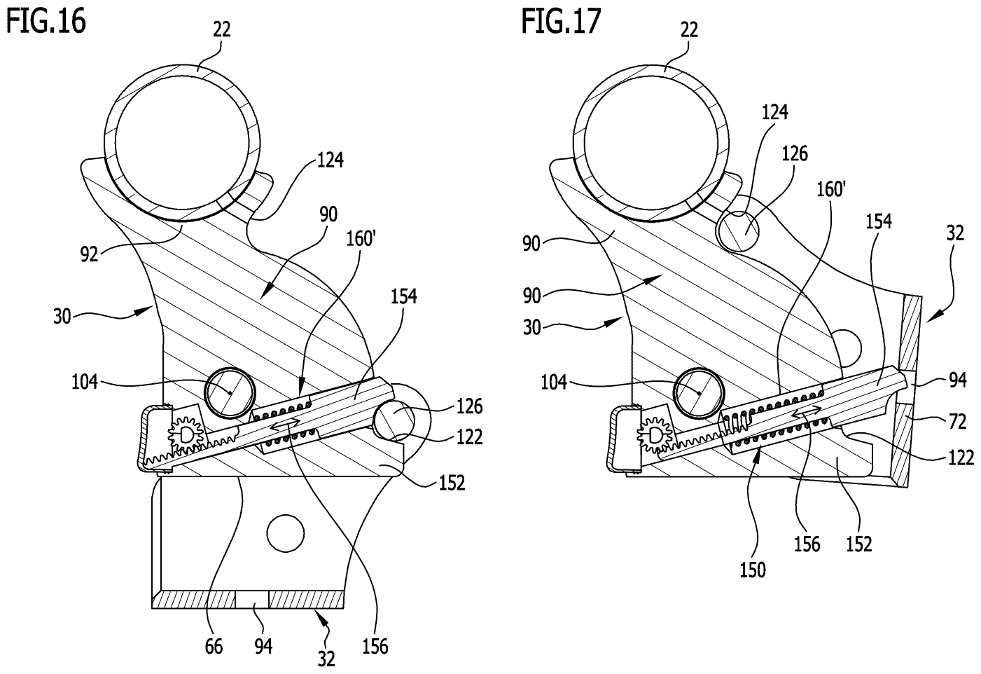

In a third exemplary embodiment, shown in FIGS. 16 and 17-insofar as no supplementary statements are made in this regard-the elements of the first and second exemplary embodiment are also realized and thus reference is made to the entire content thereof.

In contrast to the second exemplary embodiment, however, in the described variant of the actuating unit 160′ for the locking body 154, a longer travel path is provided in the actuating direction 156 so that the locking body 154 in the operating position of the receptacle body 32 shown in FIG. 16 is able, in a first fixing position, to fix the end stop body 126 relative to the operating position end stop 122, is then movable from the first fixing position according to FIG. 16 into the releasing position in which a pivoting of the receptacle body 32 about the pivot axis 104 can take place, whereafter the locking body 154 can emerge from the housing 152 over a yet longer path than in the first exemplary embodiment and can move in the movement direction 156 so far that it can cooperate with a receptacle element 194 provided in the receptacle body 32, for example a cutout in the lower transverse wall 72, in order thereby, in a second fixing position, to fix the receptacle body 32 in the rest position.

Thus, the provision of the detent nose 188 and the detent element 192 can be omitted, while as before, an actuation of the actuating unit 160 takes place in the same manner via the external operating unit 180, as described in relation to the first exemplary embodiment.

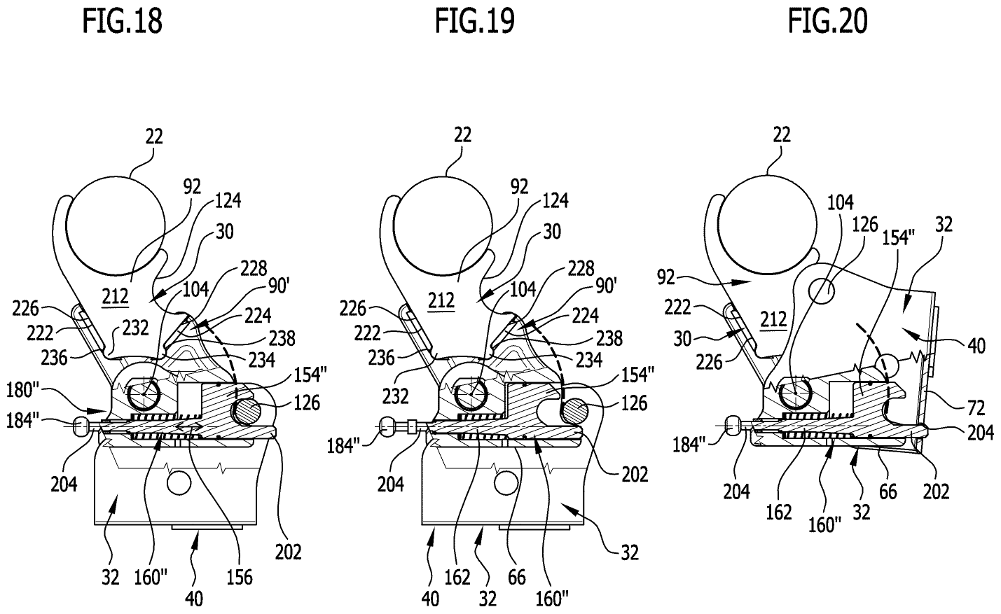

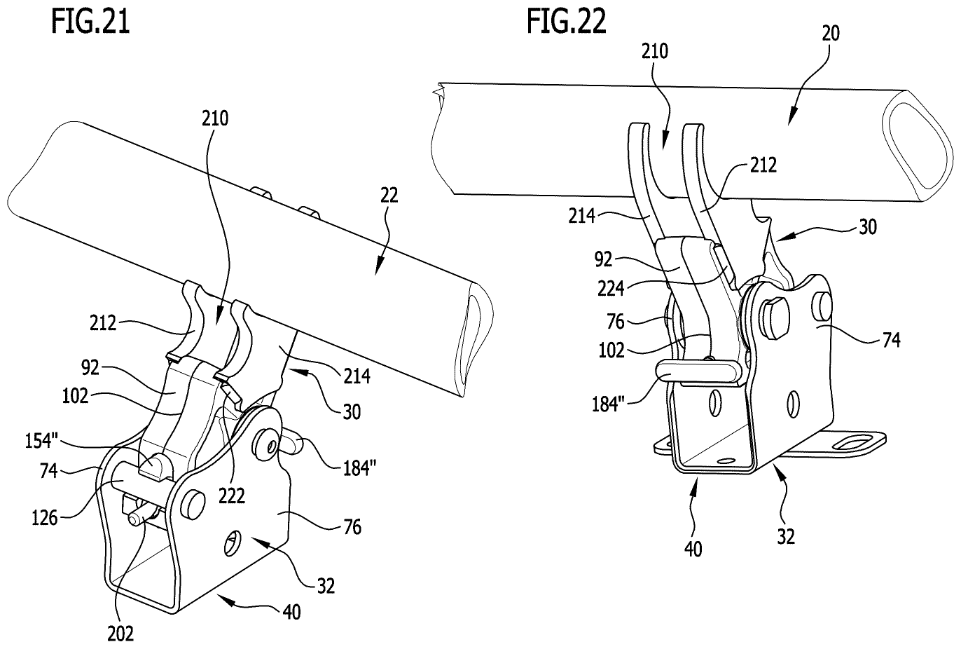

In a fourth exemplary embodiment, shown in FIGS. 18 to 22, the holding body 92 is replaced by flange elements 212 and 214, for example, planar flange elements 212, 214 which can each be formed on an external side of the guide body 90′ or, as shown in FIGS. 18 to 22, can abut it and are, firstly, fixedly connected thereto and, secondly, are fixedly connected to the transverse carrier 22.

The flange elements 212, 214 form a simple connecting unit 210 easily adaptable to different installation situations between a standardized guide body 90′ and the available space in different vehicle types, for example, vehicle types having different bumper units and bumper dimensions.

It is therein particularly advantageous if the guide body 90′ has support bodies 222 and 224 disposed outside the guide surfaces 96, 98 for the bearing cheeks 75 and 77, said support bodies preferably extending antiparallel, in particular V-shaped to one another, so that the flange elements 212, 214 can be supported thereon with suitably configured support edges 226, 228.

It is preferably further provided that the flange elements 212 and 214 engage with support edges 236, 238 of extensions 232 and 234 behind the support bodies 222 and 224 at the end side.

Thereby, the possibility exists of a positive-locking connection of the flange elements 212, 214 with the guide body 90′ which is operative in the direction parallel to their areal extent so that, in combination with a weld connection, the stability of the connection between the guide body 90′ and the flange elements 212, 214 is significantly improved.

Furthermore, the flange elements 212, 214 also each have support edges 242, 244 adapted to the form of the transverse carrier 22, said support edges peripherally abutting the transverse carrier 22, being connected thereto by welding.

With regard to the remaining features, in particular the construction of the guide body 90, the pivotable mounting and the construction of the carrier element, in particular the receptacle body 32, reference is made to the entirety of the description regarding the first exemplary embodiment.

In a fourth exemplary embodiment, shown in FIGS. 18 to 22, the elements which are identical to those of the second exemplary embodiment are not explicitly mentioned, so that in this regard, reference is made to the entirety of the description relating to the first exemplary embodiment.

In contrast to the second and third exemplary embodiment, not only the first locking body 154″ is movable with the actuating unit 160″, but a second locking body 202 is simultaneously movable with the actuating body 160″.

Preferably, therein, the first locking body 154″ and the second locking body 202 are connected to one another, in particular they are configured as a single piece, so that they are movable together with the actuating unit 160″.

Therein, in a similar manner to the second exemplary embodiment, an operating position end stop 122 can also be provided on the holding body 92.

It is also possible, however, as shown in FIGS. 18 to 22, that the second locking body 202 also forms the operating position end stop and thus in the operating position, the end stop body 126 is accommodated between the first locking body 154 and the second locking body 202 and is fixed in the operating position by the locking body 154″ and the second locking body 202.

By means of the actuating unit 160″, the first locking body 154″ can be moved from the first fixing position into the releasing position, while the second locking body 202 again also represents an end stop for the end stop body 126 in the releasing position, so that the receptacle body 32 is pivotable, starting from the releasing position of the fixing body 154″ shown in FIG. 2, only in the direction of the rest position.

In the rest position, the second locking body 202 then engages, in its second fixing position, in a receptacle 204 in the receptacle body 32, in particular in the transverse wall 72 thereof, and fixes the receptacle body 32 in the rest position.

In this case, the manual operating unit 180″ is constructed in simplified manner in that it has a handle as the actuating element 184″, which is arranged on an extension 204 of the actuating body.

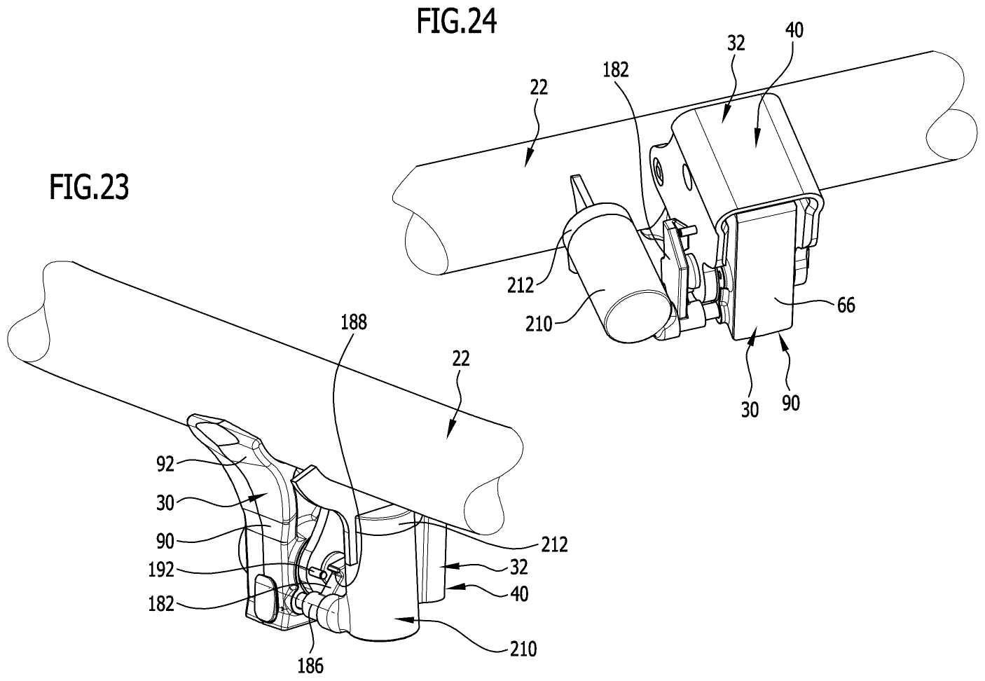

A fifth exemplary embodiment, represented in FIGS. 23 and 24 is based on the second exemplary embodiment, so that regarding the elements which are provided with the same reference signs, reference can be made to the entirety of the description of the second exemplary embodiment.

In contrast to the second exemplary embodiment, however, the pivot rocker 182 is not provided with a manual actuating element 184, but is drivable by means of a drive unit 210 which is operable by an electric control system 212 and is arranged fixed relative to the transverse carrier 22, said drive unit comprising, for example, an electric drive in order to rotate the pivot rocker 182 about the rotation axis 186 so that thereby the locking body 154 is movable from the respective fixing position into the releasing position and, furthermore, the pivot rocker 182 is also tiltable in order to fix or unblock the detent element 192 by means of the detent nose 188, as described in relation to the second exemplary embodiment.

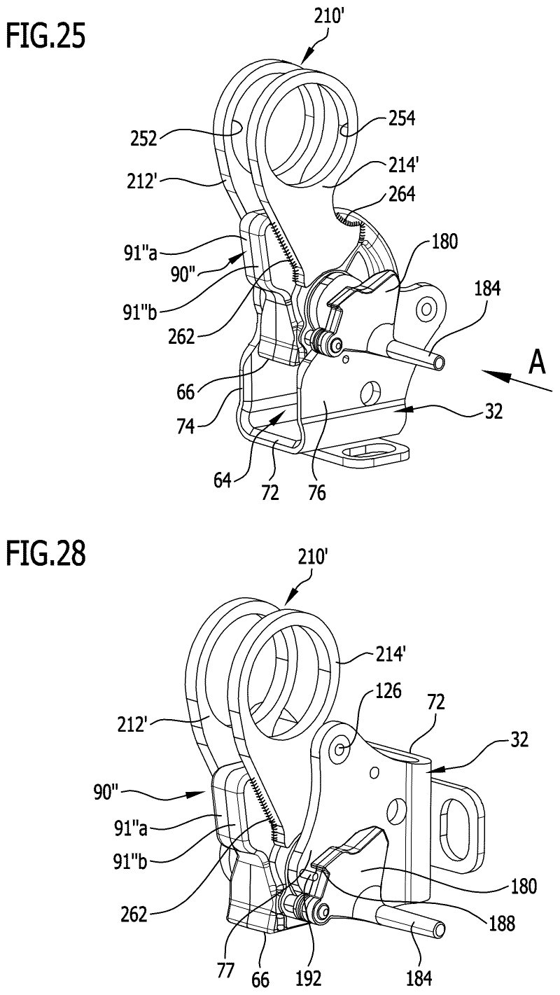

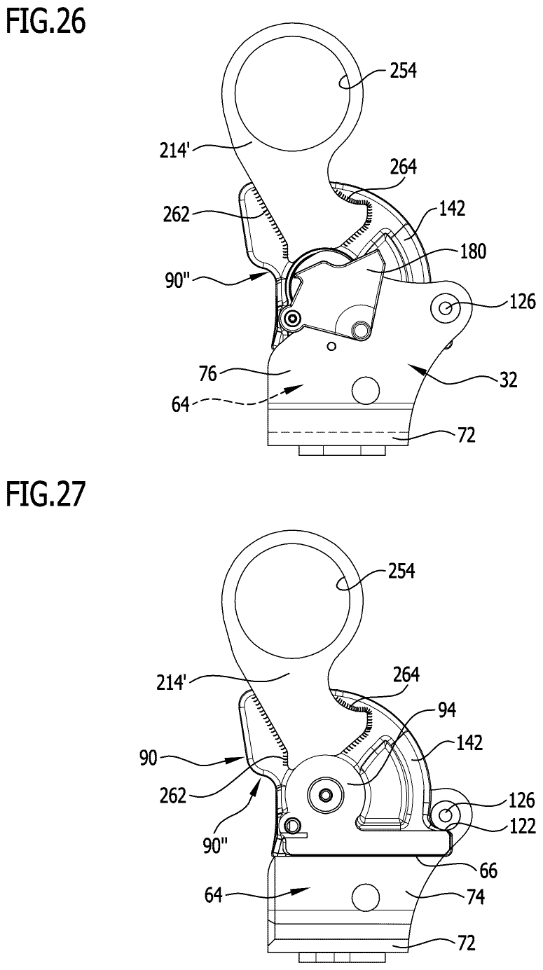

In a sixth exemplary embodiment, shown in FIGS. 25 to 28, as in the fourth exemplary embodiment, the flange elements 212′ and 214′ of the connecting unit 210′ are also provided, wherein the flange elements 212′ and 214′ are configured so that they fully encompass the transverse carrier 22 with receptacles 252 and 254 and are additionally fixable thereto by means of a weld connection.

Furthermore, in this exemplary embodiment, the flange elements 212′ and 214′ are connected by means of weld seams 262 and 264 to the guide body 90″, in particular its external sides, so that with this exemplary embodiment also, the guide body 90 is arranged between the flange elements 212′ and 214′ and is fixedly connected thereto.

In contrast to the above exemplary embodiments, the guide body 90″ is composed of two halves 91″a and 91″b which form, for example, half bodies which abut one another with their mutually facing sides and are mutually connected by joining, for example welding.

The further features, which are identical to those of the above exemplary embodiments are provided with the same reference symbols, and reference is made to the entirety of the description of these exemplary embodiments.

1. A coupling apparatus comprising a carrier unit which is mountable at a rear side on a vehicle bodywork, a holding unit held on the carrier unit and a carrier element for a coupling element, said carrier unit being mounted on the holding unit pivotable relative to said holding unit by a pivot bearing unit about a pivot axis, wherein the coupling element is configured either for pulling a trailer or for carrying a load carrier,
wherein the holding unit has a guide body on which the pivot bearing unit is arranged, by which pivot bearing unit, bearing cheeks of the carrier element are mounted on the guide body, and wherein the guide body extends with at least one portion in a direction parallel to the pivot axis from one bearing cheek to the other bearing cheek.

2. The coupling apparatus according to claim 1, wherein the guide body comprises a guide portion which carries guide surfaces arranged on both sides thereof for guiding the bearing cheeks and extends parallel to the pivot axis between these guide surfaces, in particular from one guide surface to the other guide surface.

3. The coupling apparatus according to claim 2, wherein the guide portion is a body formed by parts directly connected to one another, in particular by joining.

4. The coupling apparatus according to claim 2, wherein the guide portion is formed by a single-piece body.

5. The coupling apparatus according to claim 1, wherein the guide body extends parallel to the pivot axis with a cross-sectional area perpendicular to the pivot axis, the areal extent of said cross-sectional area corresponding to at least the areal extent of the guide surfaces.

6. The coupling apparatus according to claim 1, wherein the guide body is a body formed by parts directly connected to one another, in particular by joining.

7. The coupling apparatus according to claim 1, wherein the guide body is formed by a single-piece body.

8. The coupling apparatus according to claim 1, wherein the guide body is connected to the carrier unit by a connecting unit.

9. The coupling apparatus according to claim 8, wherein the connecting unit is formed as a single piece on the guide body.

10. The coupling apparatus according to claim 8, wherein the connecting unit is formed from two flange elements arranged spaced from one another.

11. The coupling apparatus according to claim 10, wherein the flange elements receive at least a partial region of the guide body between them.

12. The coupling apparatus according to claim 10, wherein the flange elements are fixed to mutually opposite sides of the guide body.

13. The coupling apparatus according to claim 10, wherein the flange elements are supported with support regions on support bodies arranged on the guide body.

14. The coupling apparatus according to claim 13, wherein the flange elements have support regions adapted in this manner to the support bodies and wherein, in particular, the flange elements enter into a positive-locking operative connection with the support bodies in directions parallel to their areal extent.

15. The coupling apparatus comprising a carrier unit which is mountable at a rear side on a vehicle bodywork, a holding unit held on the carrier unit and a carrier element for a coupling element, said carrier unit being mounted on the holding unit pivotable relative to said holding unit by a pivot bearing unit about a pivot axis, wherein the coupling element is configured either for pulling a trailer or for carrying a load carrier, wherein, in the rest position, the carrier element is arranged between the holding unit and a rear region of the vehicle bodywork.

16. The coupling apparatus according to claim 1, wherein the pivot axis extends transversely, in particular perpendicularly, to a vertical longitudinal central plane of the coupling apparatus.

17. The coupling apparatus comprising a carrier unit which is mountable at a rear side on a vehicle bodywork, a holding unit held on the carrier unit and a carrier element for a coupling element, said carrier unit being mounted on the holding unit pivotable relative to said holding unit by a pivot bearing unit about a pivot axis, wherein the coupling element is configured either for pulling a trailer or for carrying a load carrier, wherein the carrier element is configured as a receptacle body with a receptacle for an inserting portion of the coupling element.

18. The coupling apparatus according to claim 17, wherein, in the operating position of the receptacle body, the receptacle is arranged on a region of the guide body facing toward a roadway.

19. The coupling apparatus according to claim 17, wherein the holding unit, in particular the guide body, has a support surface which, with the inserting portion of the coupling element inserted into the receptacle of the receptacle body which is disposed in the operating position, abuts the inserting portion and thereby blocks a pivoting of the receptacle body relative to the guide body in at least one pivoting direction.

20. The coupling apparatus according to claim 19, wherein, with the inserting portion of the coupling element inserted into the receptacle body in the operating position, the support surface blocks a pivot movement of the receptacle body from the operating position in each direction.

21. The coupling apparatus according to claim 19, wherein the support surface is arranged on the guide body at a spacing from the pivot bearing unit.

22. The coupling apparatus according to claim 19, wherein the support surface is arranged on the guide body on a side of the pivot bearing unit facing toward the receptacle.

23. The coupling apparatus according to claim 19, wherein, with the receptacle body disposed in the operating position, the support surface extends parallel to a central axis of the receptacle.

24. The coupling apparatus according to claim 19, wherein, in the operating position of the receptacle body, the support surface forms, in a direction perpendicular to the central axis of the receptacle, at least a partial region, in particular the whole, of a wall surface delimiting the receptacle.

25. The coupling apparatus according to claim 19, wherein, in the operating position of the receptacle body, the support surface delimits, in the direction of the central axis of the receptacle, at least a subportion of the receptacle, in particular the whole receptacle.

26. The coupling apparatus according to claim 19, wherein, in the operating position of the receptacle body, the support surface is arranged on a side of the receptacle facing toward the pivot bearing unit.

27. The coupling apparatus according to claim 19, wherein the receptacle body is configured at least partially U-shaped in the region of the receptacle and has an open side in which, in the operating position of the receptacle body, the support surface arranged on the holding body is situated.

28. The coupling apparatus according to claim 17, wherein the holding unit, in particular the guide body thereof, has an operating position end stop which blocks a pivot movement of the receptacle body from the rest position in the direction of the operating position on reaching the operating position.

29. The coupling apparatus according to claim 17, wherein the receptacle body is provided with an end stop body which, in the operating position, abuts the operating position end stop.

30. The coupling apparatus according to claim 17, wherein there is provided on the holding unit a rest position end stop which blocks a pivot movement of the receptacle body from the operating position into the rest position on reaching the rest position.

31. The coupling apparatus comprising a carrier unit which is mountable at a rear side on a vehicle bodywork, a holding unit held on the carrier unit and a carrier element for a coupling element, said carrier unit being mounted on the holding unit pivotable relative to said holding unit by a pivot bearing unit about a pivot axis, wherein the coupling element is configured either for pulling a trailer or for carrying a load carrier, wherein a locking apparatus is arranged on the holding unit, in particular on a guide body thereof, wherein the locking apparatus is arranged in a housing held on the holding unit, wherein, by way of a locking body, the locking apparatus fixes the carrier element, at least in an operating position, relative to the holding unit, wherein the locking body protrudes in a fixing position out of the housing and cooperates with the carrier element.

32. The coupling apparatus according to claim 31, wherein the housing is included by the holding unit, in particular by a guide body thereof.

33. The coupling apparatus according to claim 31, wherein the housing is part of the holding unit, in particular of the guide body thereof.

34. The coupling apparatus according to claim 31, wherein the housing is integrated into the guide body of the holding unit.

35. The coupling apparatus according to claim 31, wherein, in the at least one fixing position, the locking body of the locking apparatus blocks a movement of the carrier element out of the operating position and is movable in a movement direction from the at least one fixing position into a releasing position in which the carrier element is freely pivotable out of the operating position into a rest position.

36. The coupling apparatus according to claim 31, wherein with the locking body, a blocking of the carrier element in the rest position takes place.

37. The coupling apparatus according to claim 31, wherein, for blocking the carrier element in the operating position, the locking body is movable into a first fixing position and, for blocking the carrier element in the rest position, is movable into a second fixing position.

38. The coupling apparatus according to claim 31, wherein the locking body of the locking apparatus is resiliently urged by an actuating unit in the direction of the at least one fixing position.

39. The coupling apparatus according to claim 38, wherein the actuating unit is arranged in the housing.

40. The coupling apparatus according to claim 38, wherein the actuating unit has an actuating body arranged in the housing, said actuating body being acted upon by a resilient element.

41. The coupling apparatus according to claim 39, wherein the housing forms a guiding receptacle for the actuating body.

42. The coupling apparatus according to claim 41, wherein the guiding receptacle for the actuating body is configured as a guide channel in the housing.

43. The coupling apparatus according to claim 40, wherein the actuating body is movable in a linear manner in the movement direction between the least one fixing position and the releasing position.

44. The coupling apparatus according to claim 31, wherein an influence on the locking body to move it in the movement direction takes place by way of an influence on the actuating unit.

45. The coupling apparatus according to claim 31, wherein the influence on the actuating unit to move the locking body from the at least one fixing position into the releasing position takes place by way of an actuating transmission.

46. The coupling apparatus according to claim 31, wherein an influence on the locking body to move it from the at least one fixing position into the releasing position takes place by way of a manual action.

47. The coupling apparatus according to claim 31, wherein an influence on the locking body to move it from the at least one fixing position into the releasing position takes place by way of a drive unit controlled by a control system.

48. The coupling apparatus according to claim 1, wherein a detent apparatus is provided for fixing the carrier element in the rest position.

49. The coupling apparatus according to claim 48, wherein an actuation of the detent apparatus to release it correlates with an influencing of the carrier element to move said carrier element from the rest position in the direction of the operating position.

50. The coupling apparatus according to claim 48, wherein the actuation of the detent apparatus correlates with the actuation of the locking body.

51. The coupling apparatus according to claim 48, wherein an influence on the locking body to move it from the at least one fixing position into the releasing position correlates with the transference of the detent apparatus from a detent position into a detent releasing position.

52. The coupling apparatus comprising a carrier unit which is mountable at a rear side on a vehicle bodywork, a holding unit held on the carrier unit and a carrier element for a coupling element, said carrier unit being mounted on the holding unit pivotable relative to said holding unit by a pivot bearing unit about a pivot axis, wherein the coupling element is configured either for pulling a trailer or for carrying a load carrier, wherein the locking apparatus is arranged on the holding unit, in particular, the guide body thereof, in a region between the carrier unit and the receptacle disposed in the operating position.

53. The coupling apparatus according to claim 52, wherein the locking apparatus is arranged on the holding unit, in particular on the guide body thereof, between bearing cheeks of the receptacle body which are mounted thereon by the pivot bearing unit.

54. The coupling apparatus according to claim 1, wherein the locking apparatus is arranged on the holding unit, in particular, on the guide body thereof, between the pivot bearing unit and the support surface.
